(19) United States
(12) Patent Application Publication
(10) Pub. No.: US 2009/0015015 A1
(43) Pub. Date: Jan. 15, 2009

(54) LINEAR POWER STATION

(76) Inventor: Risto Joutsiniemi, Viitasaari (FI)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 12/164,305

(22) Filed: Jun. 30, 2008

Related U.S. Application Data
(60) Provisional application No. 60/958,781, filed on Jul. 9, 2007.

(51) Int. Cl. F03D 9/00; H02K 7/18; F03B 13/10

(52) U.S. Cl. 290/54; 290/52

(57) ABSTRACT

A linear power station, includes a turbine array comprised of a plurality of turbines, the turbines for harnessing the power of a moving fluid and each respective turbine being rotatable about a fixed axis of rotation by fluid flow that is omnidirectional with respect to the turbine, and a generator array comprised of at least one generator, the at least one generator being operably coupled to the turbine array for being rotated by the respective plurality of turbines of the turbine array.

A method of producing electrical power is further included.

### RELATED APPLICATIONS

The present application claims the benefit of U.S. Provisional Application No. 60/958,781, filed Jul. 7, 2007 and included herein in its entirety by reference.

### FIELD OF THE INVENTION

The present invention relates to fluid operated turbines. More particularly, the present invention relates to a plurality of fluid operated turbines integrated into a linear power station, particularly a linear power station that is integrated with a humanly occupiable building structure.

### DESCRIPTION OF RELATED ART

The fluid turbines described herein are described and claimed in Canadian Patent 1,236,030, issued May 3, 1988, having common ownership with the present application and incorporated herein in its entirety by reference. No claim of priority to such patent is made hereby.

### BACKGROUND OF THE INVENTION

Known wind turbines typically have a rotatable central hub coupled to a plurality of radially mounted blades much like the propeller of a propeller driven aircraft. Such blades travel in a generally vertical arc with the hub. The rotation of the blades at speeds sufficient to generate a desired amount of electrical power results in a relatively high tip speed of the blades. The high tip speed generates undesirable noise that has been associated with health issues. Additionally, such wind turbines result in the death and maiming of many birds indigenous to the area in which the wind turbine is mounted.

The wind turbines described above are additionally not omnidirectional. Such wind turbines must be faired into the prevailing wind, usually by generally rotating the hub and propeller horizontally on the supporting mast, in order to capture the energy of the prevailing wind. The volume of space required for the operation of such turbines is at least the blade tip-to-tip distance in both the vertical and horizontal directions. This is a considerable and undesirably large volume, especially for use in inhabited areas. The radial disposition of the blades relative to the hub requires that a significant volume be dedicated to the wind turbine. When attempting to integrate a non-vertical (or propeller type) wind turbine with a humanly occupiable building structure, such dedicated volume detracts from the usefulness of the nonvertical wind turbine and adversely affects the building design.

There is a need then in the industry for a relatively quiet wind turbine couplable into a linear power station that generates no potential health issues with its rotation and that does not adversely affect the local bird population. Additionally, there is a need for an omnidirectional wind turbine in a linear power station that need not be faired into the prevailing fluid flow in order to effect rotation thereof. Further, a wind turbine of reduced size for the power generated for incorporation in a linear power station is desirable.

### SUMMARY OF THE INVENTION

The linear power station of the present invention substantially meets the aforementioned needs of the industry and society, in general. The helical design of the turbines incorporated into the linear power station makes the turbines omnidirectional. Fluid flow from any direction bears on the helical blades and rotates the blade portion of the turbine.

Additionally, as noted in WS-0.30BN noise rapport (sic), dated 2006 Oct. 27 from the University of Vaasa (attached hereto) the Windside™ vertical wind turbine model WS-0.30B was subjected to a standardized noise test and determined to be virtually silent.

Further, the turbine of the present invention incorporated into the linear power station of the present invention occupies a significantly smaller volume with respect to known non-vertical (propeller type) wind turbines of equal power generation.

The present invention is a linear power station, and includes a turbine array comprised of a plurality of turbines, the turbines for harnessing the power of a moving fluid and each respective turbine being rotatable about a fixed axis of rotation by fluid flow that is omnidirectional with respect to the turbine, and a generator array comprised of at least one generator, the at least one generator being operably coupled to the turbine array for being rotated by the respective plurality of turbines of the turbine array. The present invention is further a method of producing electrical power.

### BRIEF DESCRIPTION OF THE DRAWINGS

FIG. 1 is a perspective view of a linear power station incorporating a plurality of vertical wind turbines integrated with a humanly occupiable building structure;

FIG. 1b is a perspective view of a linear power station incorporating a plurality of vertical wind turbines integrated along the top perimeter of a humanly occupiable building structure;

FIG. 2 is a perspective view of the linear power station depicted in FIG. 1;

FIG. 2a is a perspective view of the linear power station for powering the lights of a light standard in an urban setting;

FIG. 2b is a perspective view of the linear power station for powering the lights of a light standard in a rural or park setting;

FIG. 2c is a perspective view of the linear power station included on power line structures;

FIG. 3 is a perspective view of a humanly occupiable building structure formed in two towers having the linear power station arrayed between the two towers;

FIG. 4 is an elevational view of a noise barrier incorporating the linear power station of the present invention;

FIG. 4a is an elevational view of a storm/flood barrier incorporating the linear power station of the present invention;

FIG. 5 is an elevational view of two linear power stations integrated with respective adjacent humanly occupiable building structures, the vertical wind turbines being mounted in a vertical stack and rotating in opposite directions;

FIG. 5a is an elevational view of two linear power stations integrated with respective adjacent humanly occupiable building structures, the vertical wind turbines being mounted in a vertical stack and rotating in the same clockwise direction;

FIG. 5b is an elevational view of two linear power stations integrated with respective adjacent humanly occupiable building structures, the vertical wind turbines being mounted in a vertical stack and rotating in the same counter clockwise direction;

FIG. 5c is a top plain form view of a humanly occupiable building structure with vertical wind turbines being mounted at each corner thereof, two of the vertical wind turbines being clockwise rotatable and the other two of the vertical wind turbines being counter clockwise rotatable;

FIG. 6 is an elevational depiction of the vertically stacked linear power station of FIG. 5;

FIG. 7 is an elevational depiction of a humanly occupiable building structure with a vertically stacked linear power station mounted atop the building and depicting interchangeable turbines of different size as desired;

FIG. 8 is an elevational view of a linear power station suspended from a buoy with turbines both exposed to air currents and water currents;

FIG. 8a is an elevational view of a linear power station suspended from a buoy/pontoon structure with turbines exposed to water currents;

FIG. 9 is an elevational view of a linear power station with horizontally disposed turbines attached to the bed of a body of water; and

FIG. 9a is an elevational view of a linear power station with vertically disposed turbines attached to the bed of a body of water.

### DETAILED DESCRIPTION OF THE DRAWINGS

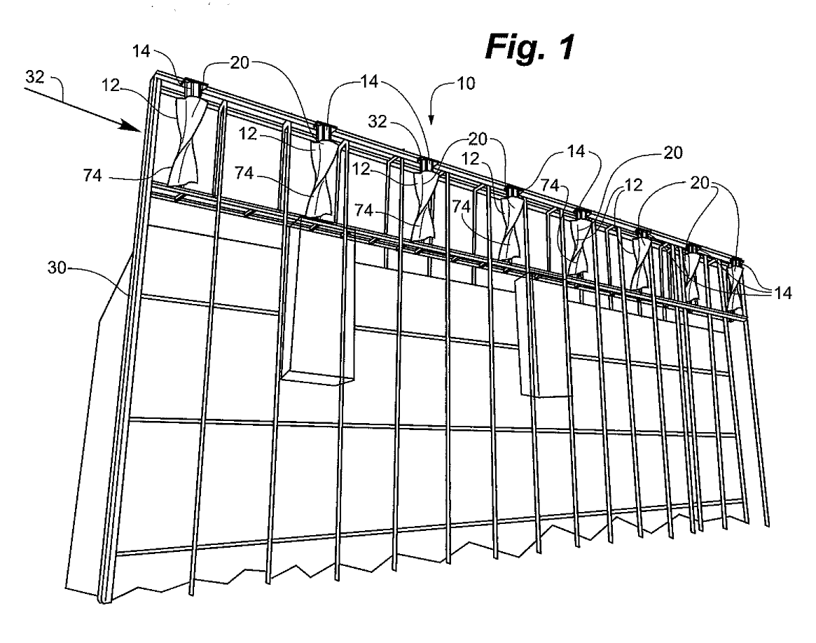

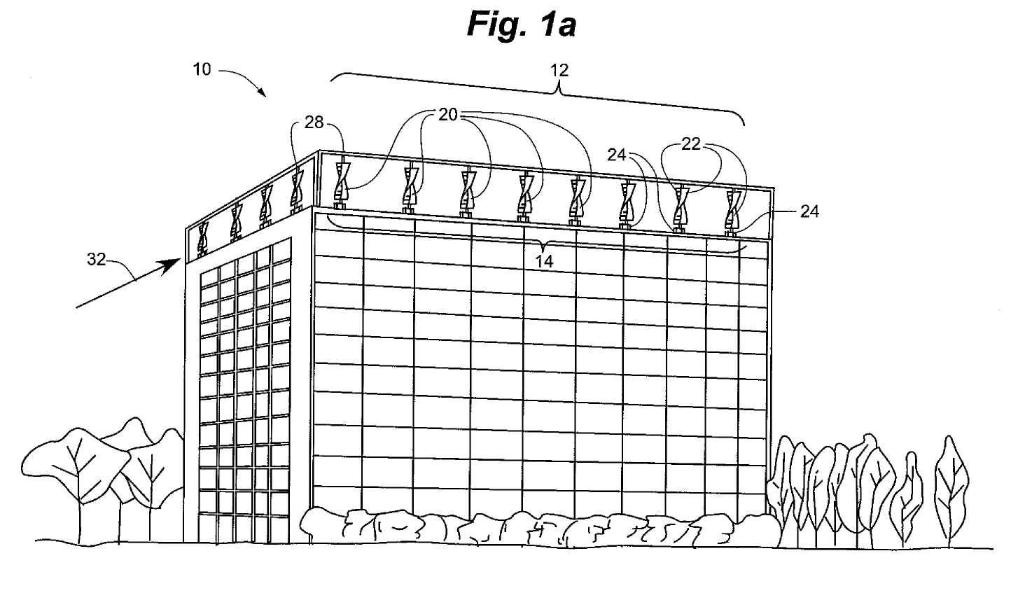

The linear power station of the present invention is shown generally at 10 in the figures. Each of the linear power stations 10, depicted generally in FIGS. 1 and 1a, is comprised of a turbine array 12 and a generator array 14. The turbine array 12 preferably includes plurality of turbines 20. The generator array 14 preferably includes at least one generator 24 in rotational communication with the turbines 20 or a plurality of generators 24, each respective generator 24 being in rotational communication with a respective turbine 20. In an embodiment, the individual generators 24 comprising the generator array 14 are in electrical communication.

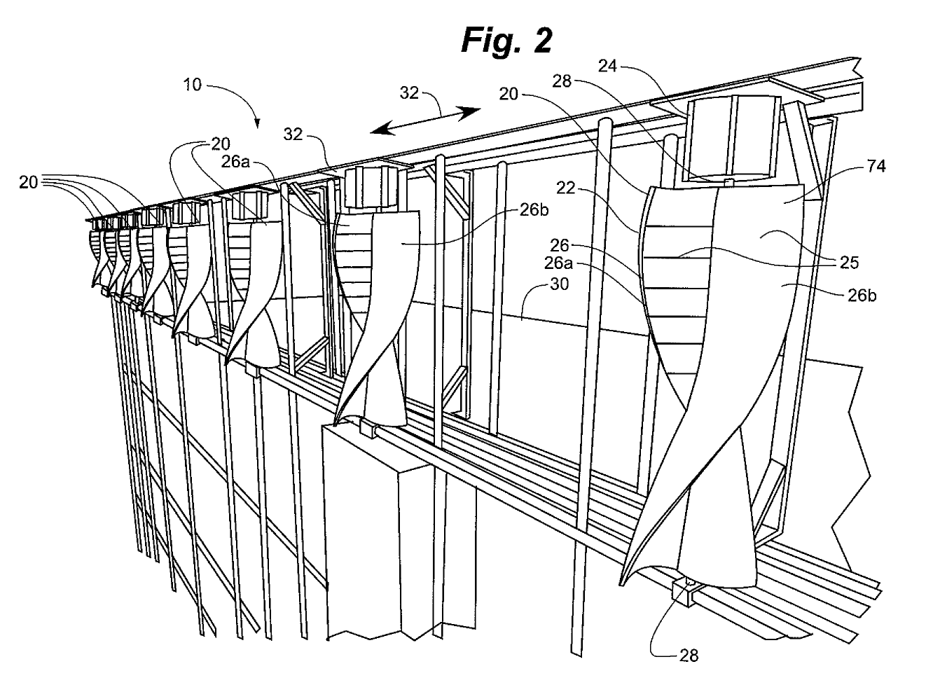

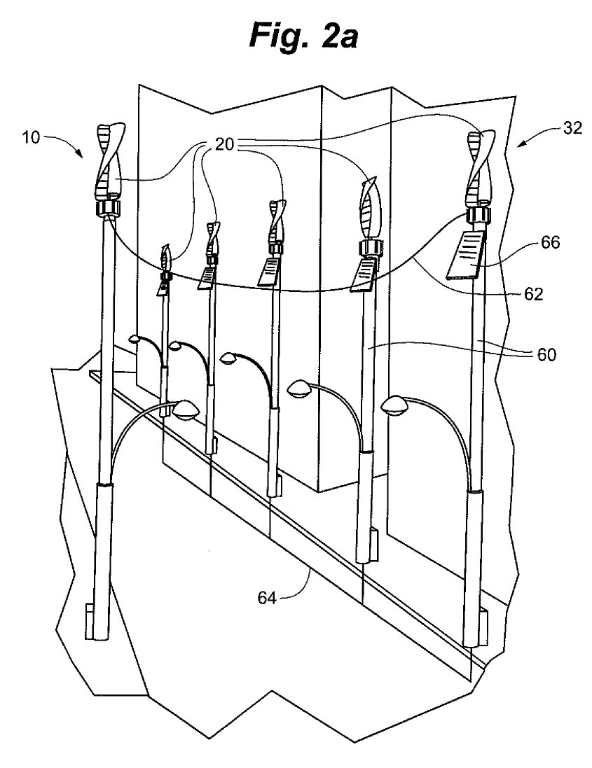

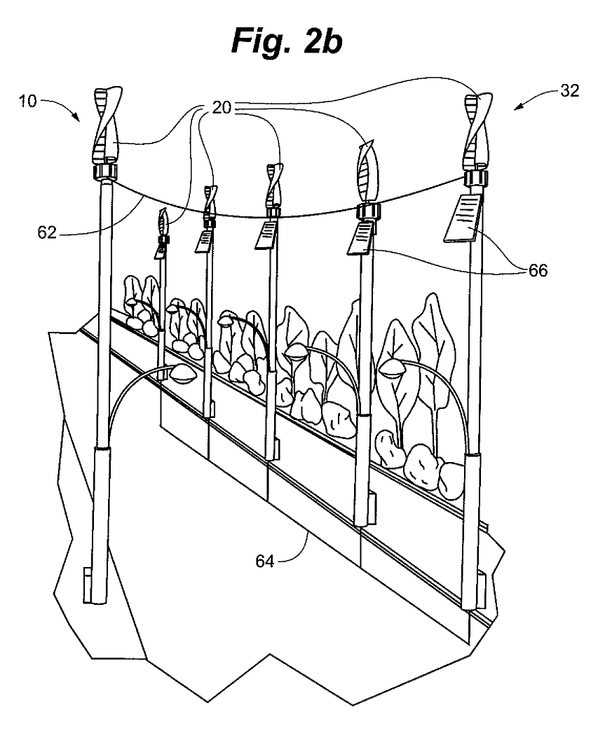

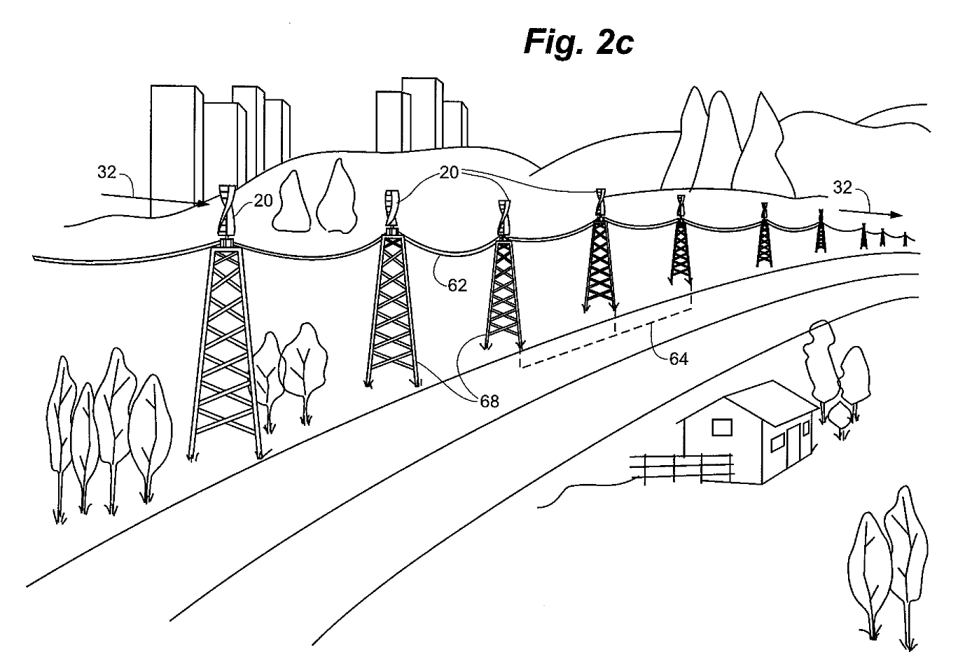

Referring to FIG. 2, the turbines 20 of this embodiment have two major subcomponents; blade portion 22 and generator 24. The blade portion 22 includes flighting 74, the flighting 74 including a plurality of flights 25 integrated into the blade portion 22 and preferably extending the full height dimension of the blade portion 22. Preferably the flighting 74 is comprised of flights 25, each flight 25 thereof preferably being formed of a respective one of two cooperative helixes 26a, b. The blade portion 22 is mounted on a vertical shaft 28. The vertical shaft 28 is rotatably mounted to suitable structure at its lower end, as by bushings or the like. At its upper end, the vertical shaft 28 is rotatably connected to generator 24. Generator 24 could as well be located at the opposite end of shaft 28.

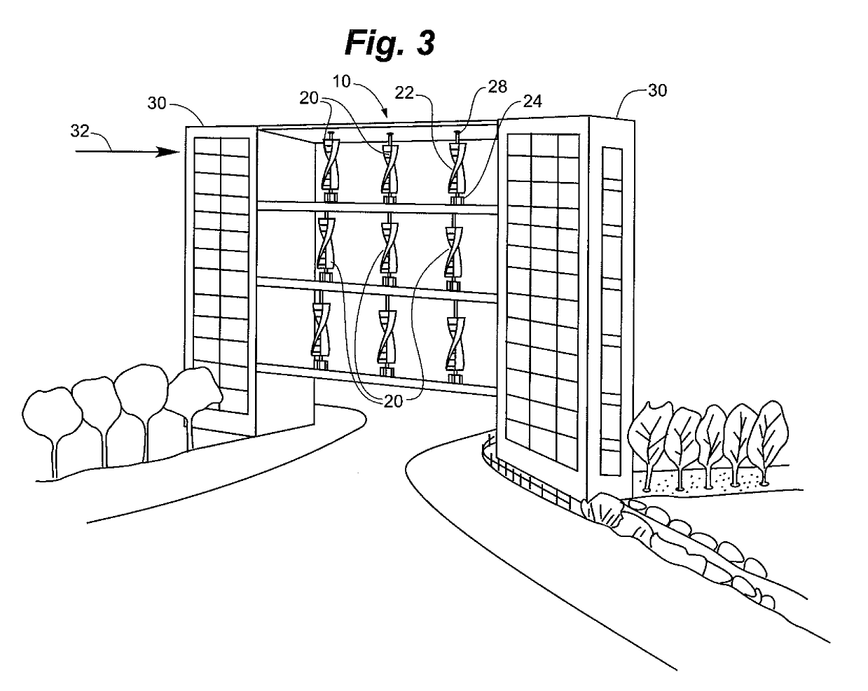

Generator 24 may be a conventional generator that converts the rotational motion of the shaft 28 into electrical power. In a horizontal array 32 as depicted in FIGS. 1-3, each of the vertical wind turbines 20 has both a blade portion 22 and an associated generator 24. The generator 24 of the individual turbines 20 that comprise generator array 14 of the linear power station 10 maybe connected either in series electrical connection or in parallel electrical connection as desired.

Such horizontal arrays 32 of the linear power station 10 are depicted incorporated into an array of street lights 60 in FIGS. 2a, 2b. The linear power station 10 thereof may be connected by overhead power lines 62 or buried power lines 64. Solar generators 66 may be incorporated as well into the linear power station 10 to supplement the electrical energy generated by fluid flow.

As depicted in FIG. 2c, such horizontal arrays 32 of the linear power station 10 are depicted incorporated into an array of preexisting or dedicated power line structures 68 by mounting the turbines 20 (and associated generators 24) to the top of the dedicated power line structures 68. The linear power station 10 thereof may be connected by overhead power lines 62 or buried power lines 64, as desired.

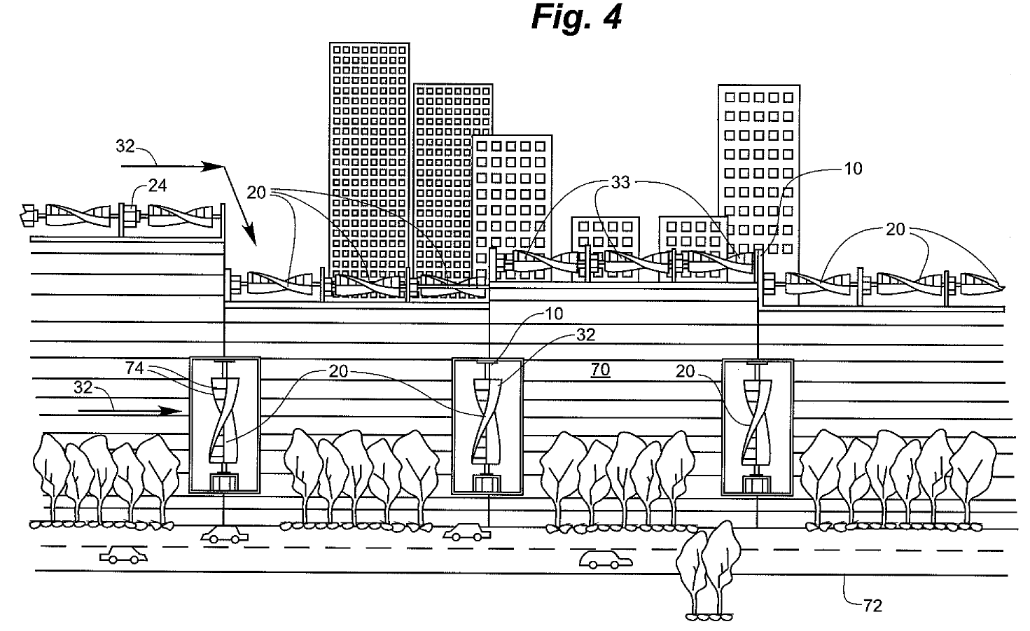

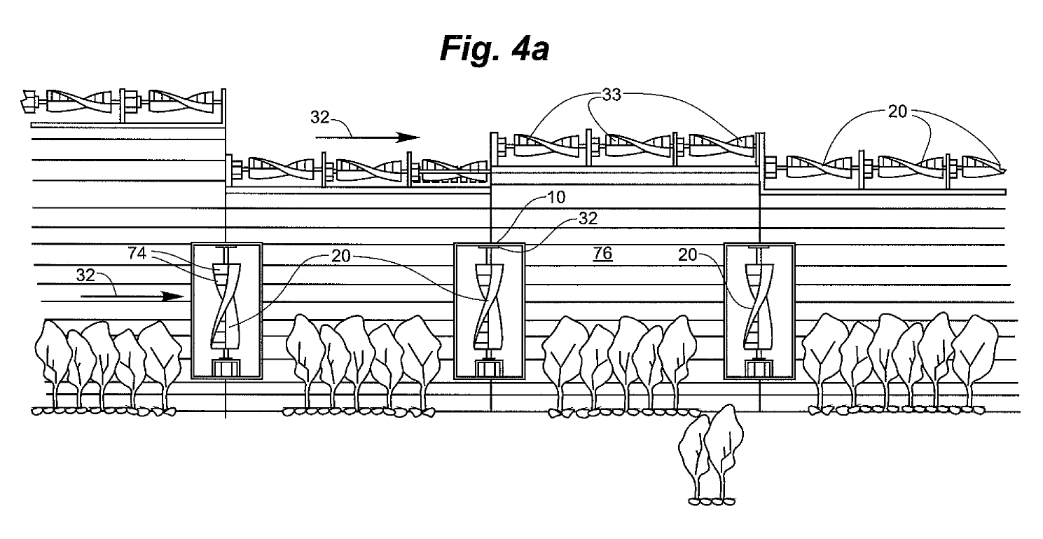

Such horizontal arrays 32 of the linear power station 10 are further depicted incorporated into a sound barrier 70 in FIG. 4 and storm wall 76 in FIG. 4a. The individual turbines 20 may be horizontally or vertically disposed as desired. The soundlessness of the individual turbines 20 is useful in absorbing the sound generated on the freeway 72. Additionally, the flighting 74 of the individual turbines 20 can be artistically colored and/or decorated to present an attractive, rotating image on the otherwise drab appearance of the barrier 70.

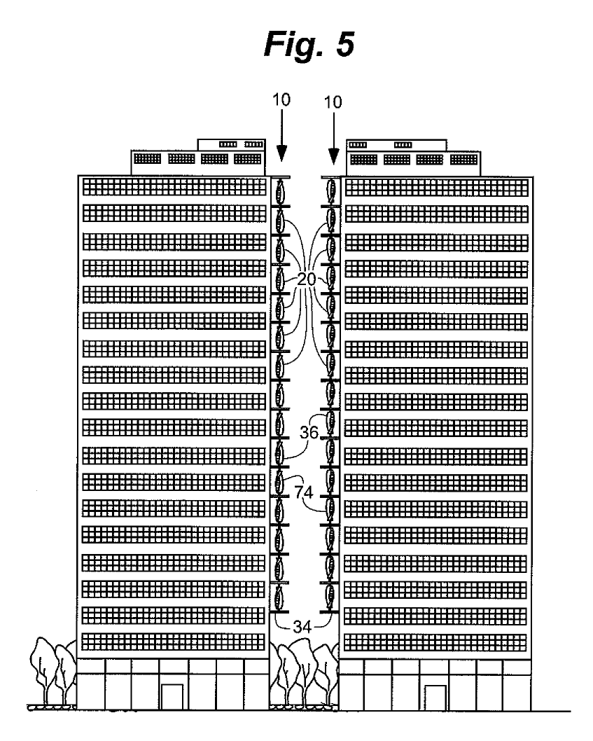

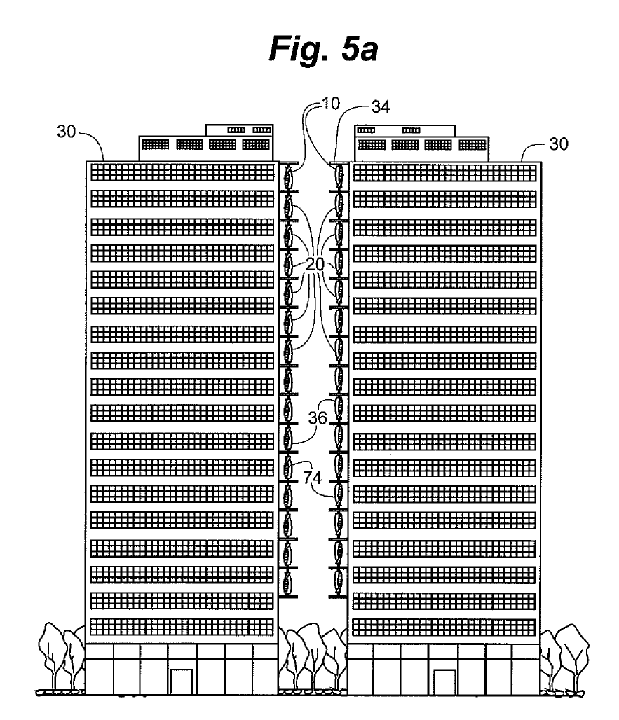

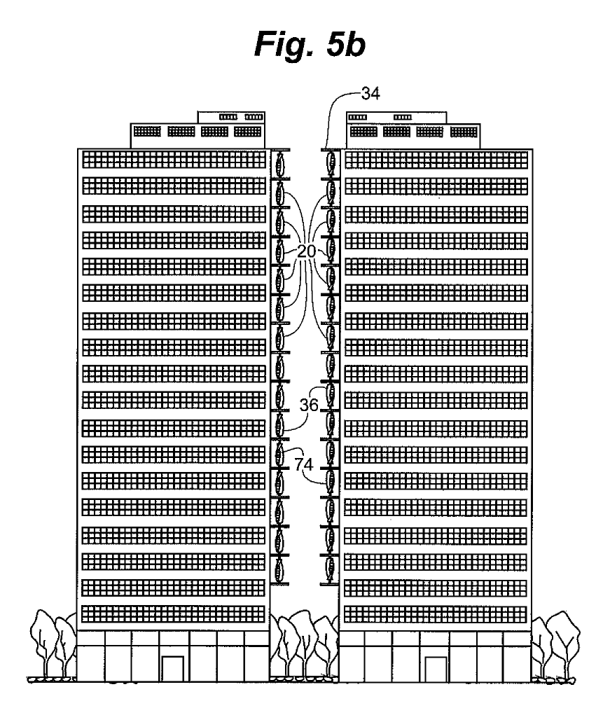

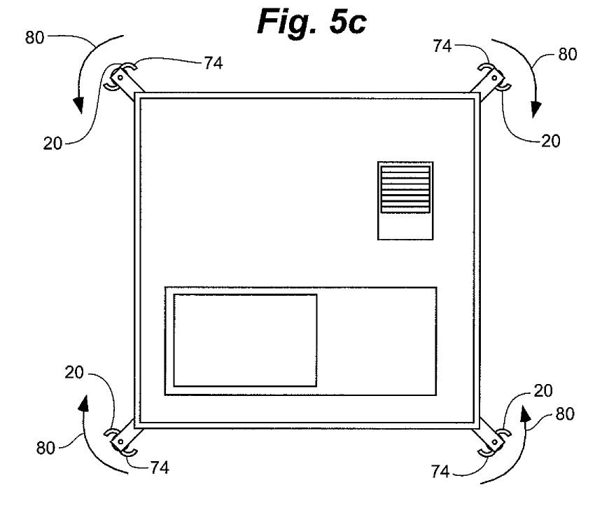

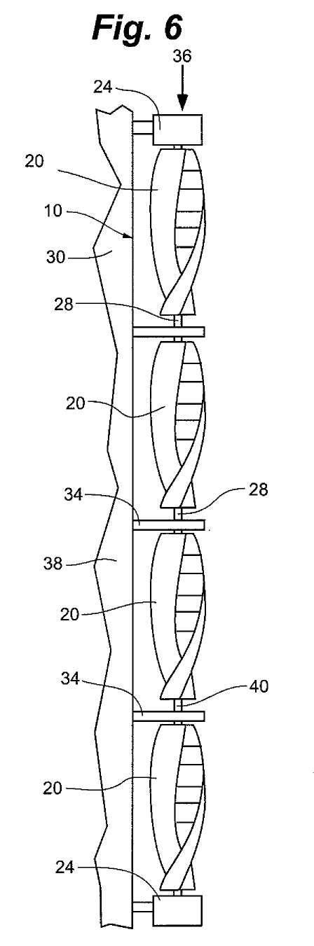

Vertical stacks 36 of the linear power station 10 are depicted in FIGS. 5-7. In a vertical stack 36, as depicted in FIGS. 5 and 6, the vertical stack 36 is mounted to the building 38 by mounts 34, disposed between vertically adjacent vertical wind turbines 20. Each of the mounts 34 includes a bushing 40 for rotatably supporting a common vertical shaft 28. As depicted in FIG. 6, the vertical shaft 28 is common to all four vertically stacked vertical wind turbines 20 and rotatably coupled to generator 24 at the top of the vertical stack 36. In such disposition, the cooperative rotation of the four vertical wind turbines 20 act to drive the single vertical shaft 28 and, thereby, the generator 24 derives electrical power from the rotation of all four of the vertical wind turbines 20. As depicted in FIGS. 5a-5c, the twist of the flighting 74 way be either of two opposed directions to produce opposed directions of rotation of the turbines 20, either clockwise or counter clockwise, as noted by arrows 80 of FIG. 5c.

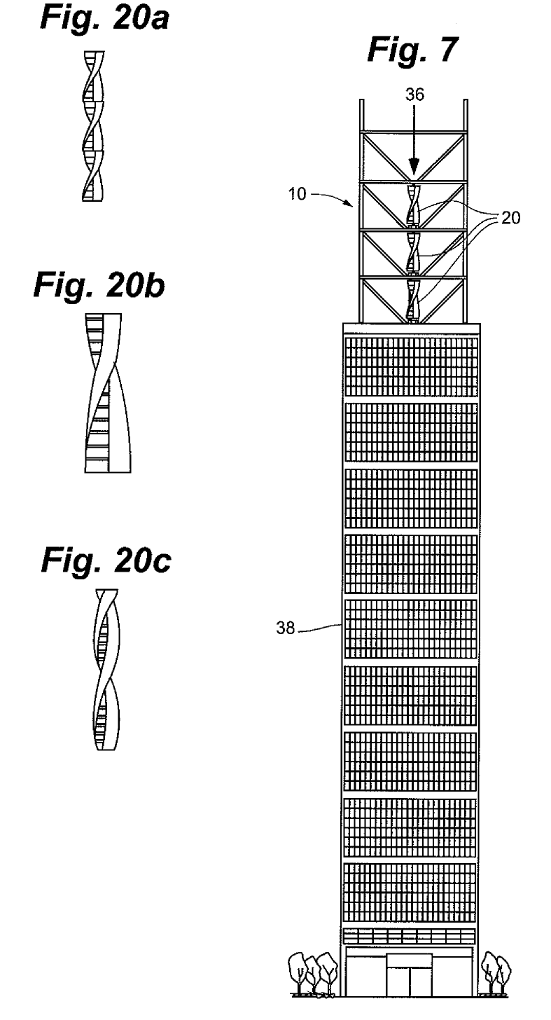

FIG. 7 depicts a building 38 with a linear power station 10 mounted from the top of the building 38. The linear power station 10 is configured in a vertical stack 36 comprising three vertical wind turbines 20 mounted a common shaft and all cooperatively powering the generator 24. Various sized turbines 20a, 20b are available for incorporation into the linear power station 10.

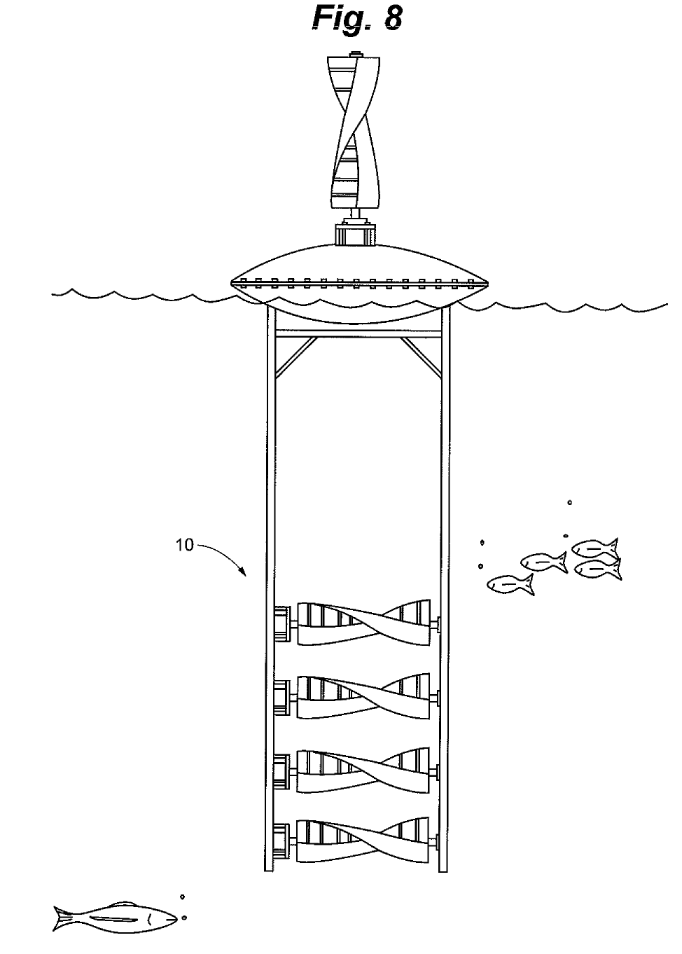

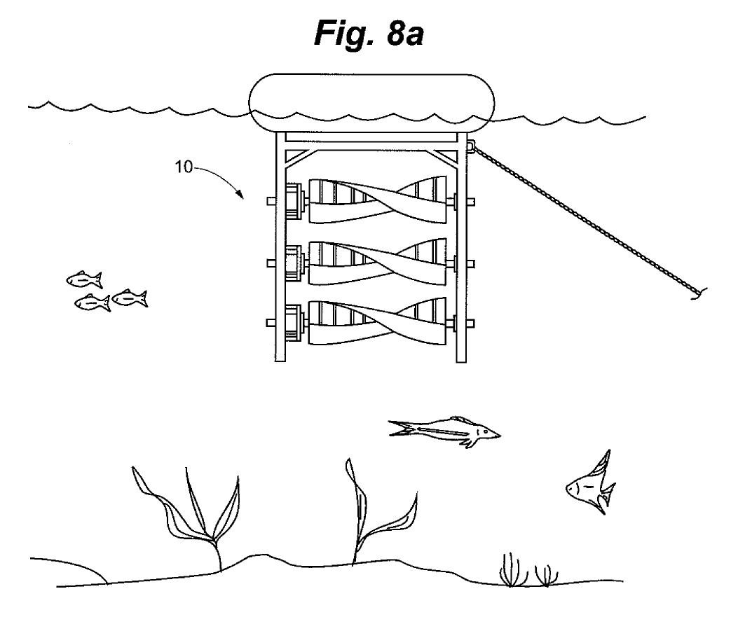

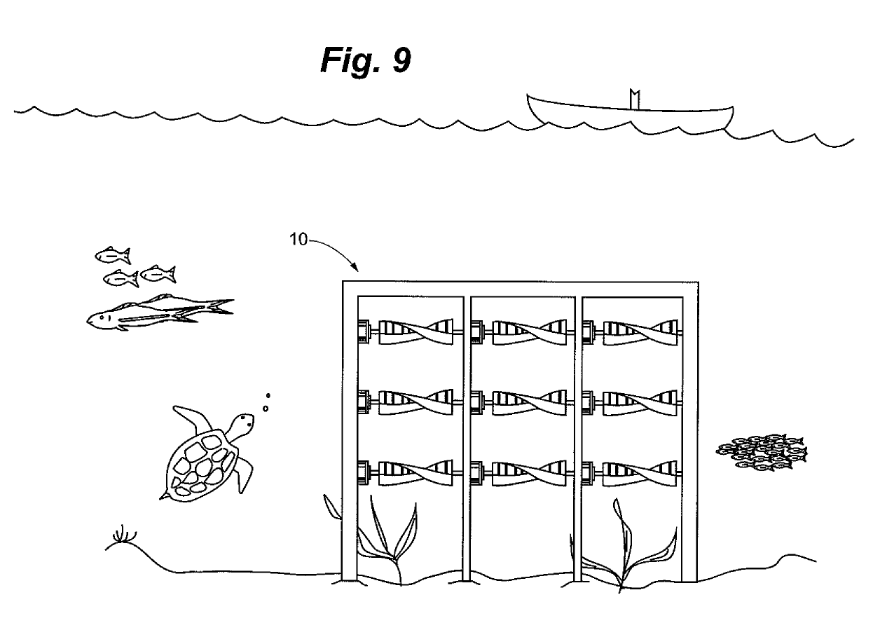

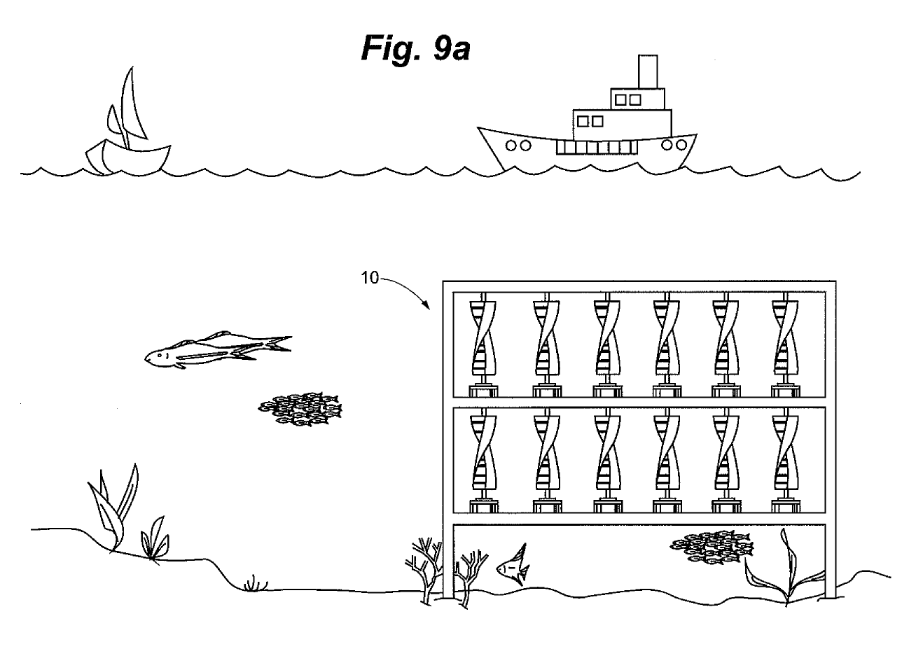

It should be noted that the vertical wind turbines 20 that comprise the linear power station 10 are fluid powered. While the description above generally relates to powering the individual turbines 20 by means of a gas (air, in this case) the vertical wind turbines 20 can as well be driven by any fluid, including a liquid, such as water. Accordingly, a plurality of vertical wind turbines 20 may be integrated into a linear power station 10 that is placed on the bed of a body of water. Currents in the water then rotate the individual vertical wind turbines 20 of linear power station 10. Such uses are depicted in FIGS. 8-9a. It should be noted that rotation generated by water flow/currents is capable of generating significantly more electrical energy that that produced by wind power, potentially as much as 800 times as much energy. Water flow may occur as a result of currents, tides, and river flow. Such application of the linear power station 10 has the additional societal advantages of being out of sight, being completely silent, and being entirely environmentally friendly.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives.

1. A linear power station, comprising:
a turbine array comprised of a plurality of turbines, the turbines for harnessing the power of a moving fluid and each respective turbine being rotatable about a fixed axis of rotation by fluid flow that is omnidirectional with respect to the turbine; and
a generator array comprised of at least one generator, the at least one generator being operably coupled to the turbine array for being rotated by the respective plurality of turbines of the turbine array.

2. The linear power station of claim 1, the generator array having a generator operably coupled to each of the respective turbines comprising the turbine array, each of the respective generators being in electrical communication with the other generators comprising the generator array.

3. The linear power station of claim 1, each of the respective turbines comprising the turbine array having a blade portion, the blade portion including flighting having at least one helical flight.

4. The linear power station of claim 1, the turbine array being disposable in a moveable gas for being rotated thereby.

5. The linear power station of claim 1, the turbine array being disposable in a moveable liquid for being rotated thereby.

6. The linear power station of claim 1, the turbine array having a common rotatable shaft, each of the plurality of turbines comprising the turbine array being operably coupled to the common shaft.

7. The linear power station of claim 1, the turbine array having a common rotatable shaft, a generator comprising the generator array being operably coupled to the common shaft.

8. A linear power station, comprising:
turbine array means for being comprised of a plurality of turbine means, the turbine means for harnessing the power of a moving fluid and each respective turbine means being rotatable about a fixed axis of rotation by fluid flow that is omnidirectional with respect to the turbine means; and
generator array means for being comprised of at least one generator means, the at least one generator means being operably coupled to the turbine array means for being rotated by the respective plurality of turbine means of the turbine array means.

9. The linear power station of claim 8, the generator array means having a generator means operably coupled to each of the respective turbine means comprising the turbine array means, each of the respective generator means being in electrical communication with the other generator means comprising the generator array means.

10. The linear power station of claim 8, each of the respective turbine means comprising the turbine array means having a blade portion, the blade portion including flighting having at least one helical flight.

11. The linear power station of claim 8, the turbine array means for being disposable in a moveable gas for being rotated thereby.

12. The linear power station of claim 8, the turbine array means for being disposable in a moveable liquid for being rotated thereby.

13. The linear power station of claim 8, the turbine array means having a common rotatable shaft, each of the plurality of turbine means comprising the turbine array means for being operably coupled to the common shaft.

14. The linear power station of claim 13, the turbine array means having a common rotatable shaft, a generator means comprising the generator array means for being operably coupled to the common shaft.

15. A method of producing electrical power, comprising:
forming a linear power station, the linear power station including;
forming a turbine array of a plurality of turbines, harnessing the power of a moving fluid by means of the turbines and rotating each respective turbine about a fixed axis of rotation by fluid flow that is omnidirectional with respect to the turbine; and
forming a generator array of at least one generator, operably coupling the at least one generator to the turbine array for being rotated by the respective plurality of turbines of the turbine array.

16. The method of claim 15, including operably coupling the generator array having a generator to each of the respective turbines comprising the turbine array, and electrically communicating each of the respective generators being with the other generators comprising the generator array.

17. The method of claim 15, including a blade portion on each of the respective turbines comprising the turbine and including flighting having at least one helical flight on each of the respective blade portions.

18. The method of claim 15, including disposing the turbine array in a moveable gas for being rotated thereby.

19. The method of claim 15, including disposing the turbine array in a moveable liquid for being rotated thereby.

20. The method of claim 15, including providing the turbine array with a common rotatable shaft and operably coupling each of the plurality of turbines comprising the turbine array to the common shaft.

21. The method of claim 15, including providing the turbine array with a common rotatable shaft and operably coupling a generator comprising the generator array to the common shaft.
